(19) United States
(12) Patent Application Publication
(10) Pub. No.: US 2010/0250324 A1
(43) Pub. Date: Sep. 30, 2010

(54) PROVIDING LOCAL CONTEXTUAL INFORMATION WITH CONTEXTUAL ADVERTISEMENTS

(75) Inventor: Juveria Kanodia, Kirkland, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/410,199

(22) Filed: Mar. 24, 2009

(51) Int. Cl. G06Q 30/00; G06Q 10/00

(52) U.S. Cl. 705/10; 705/14.58

(57) ABSTRACT

Computer systems, methods and media for providing local contextual information in association with contextual advertisements are provided. A contextual advertisement is received, as is a location associated with a user. It is determined if any local contextual information relevant to the user's location is available for presentation. Upon determining that local contextual information is available for presentation, such local contextual information is presented along with the contextual advertisement, at least upon receipt of appropriate user behavior evidencing a desire to view the local contextual information.

### BACKGROUND

Advertisements (hereinafter “ads”) include contextual ads and, as used herein, generally refer to ads that are aware of the content of the web resource (e.g., websites, web pages, Uniform Resource Locators (URLs), Uniform Resource Identifiers (URIs), and the like) hosting the advertisement. Contextual ads generally list a business name, a business description, and a business URL. Such ads operate on the premise that the viewing user is an Internet shopper. However, some users do not wish to make online purchases for various reasons including privacy concerns, security concerns, a lack of available online payment instruments, or simply a personal preference. Such users are required to possess the motivation to navigate to the business URL via the ad, and search for local stores, if any, to make an in-store purchase. The result is typically that the user ignores the ad altogether.

### SUMMARY

Embodiments of the present invention generally relate to systems, methods, and computer-storage media having computer-executable instructions embodied thereon that, when executed, perform methods for improving the relevance of contextual ads presented to a user in association with a web resource. Utilizing the systems, methods, and computer-storage media described herein, an ad is received. Additionally, a location associated with a user is received. The location associated with the user allows for identification of local contextual information. The local contextual information is associated with the ad and the ad is presented to the user. Specific embodiments of the present invention relate to presenting a user with in-store purchase options via a contextual ad. Local contextual information is presented to the user, after determining the relevancy thereof, with the results presented in order of relevance.

This Summary is provided to introduce a selection of concepts in a simplified form. The selection of concepts is further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a schematic diagram of an exemplary network operating environment suitable for use in implementing embodiments of the present invention;

FIG. 3 is a flow diagram illustrating a method for providing local contextual information in association with contextual ads, in accordance with an embodiment of the present invention;

FIG. 4 is a flow diagram illustrating a method for presenting local contextual information associated with contextual ads to a user in association with a web resource, in accordance with an embodiment of the present invention; and

FIG. 5 is a flow diagram illustrating a method for improving the relevance of contextual ads presented to a user in association with a web resource, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, embodiments of the present invention are described in detail below with reference to the attached drawing figures, which are incorporated in their entirety by reference herein.

Embodiments of the present invention relate to systems, methods, and computer-storage media having computer-executable instructions embodied thereon that, when executed, perform methods in accordance with embodiments hereof, for providing local contextual information in association with contextual ads presented to a user in association with web resources. Utilizing the systems, methods, and computer-storage media described herein, an ad is received. Additionally, a location associated with a user is received. The location associated with the user allows for identification of local contextual information. Upon identification, the local contextual information is associated with the ad and the ad is presented to the user. Specific embodiments of the present invention relate to presenting a user with offline, in-store purchase options via a contextual ad. Local contextual information is presented to the user, after determining the relevancy thereof, with the results presented in order of relevance.

Accordingly, in one embodiment, the present invention is directed to one or more computer-storage media having computer-executable instructions embodied thereon that, when executed, perform a method for providing local contextual information in association with contextual ads presented to a user in association with a web resource. The method includes receiving a contextual ad for presentation to a user; and receiving location information associated with the user. Based on the user's location information, local contextual information is identified that includes at least one entity identifier that identifies an entity associated with the ad and an offline location associated with the identified entity. The ad and the local contextual information are then presented to the user.

In another embodiment, the present invention is directed to a computer-implemented method that, when executed by a computing device, presents local contextual information in association with contextual ads to a user in association with a web resource. The method includes receiving an indication of a user's desire to view local contextual information associated with a presented contextual ad. The local contextual information includes at least one entity identifier that identifies an entity associated with the ad and an offline location associated with the identified entity. Utilizing a computing device, it is next determined if the identified entity is associated with a customized local contextual information display. If it is determined that the identified entity is associated with a customized local contextual information display, the local contextual information is presented via the customized local contextual information display. If it is determined that the entity is not associated with a customized local contextual information display, the local contextual information is presented via a non-customized local contextual information display.

In yet another embodiment, the present invention is directed to one or more computer-storage media having computer-executable instructions embodied thereon that perform a method for improving the relevance of contextual ads presented to a user in association with a web resource. The method includes receiving a contextual ad and receiving a location associated with the user. Based on the user's location, local contextual information is identified, wherein the local contextual information includes at least one non-web-based entity identifier that identifies a non-web-based entity associated with the contextual ad and a location associated with the non-web-based entity. The contextual ad and a local contextual information indicator are presented. The method further includes receiving an indication of the user's desire to view the local contextual information associated with the presented contextual ad, and utilizing a computing device to determine whether the non-web-based entity is associated with a customized local contextual information display. If it is determined that the non-web-based entity is associated with a customized local contextual information display, the local contextual information is presented via the customized local contextual information display. If it is determined that the non-web-based entity is not associated with a customized local contextual information display, the local contextual information is presented via a non-customized local contextual information display.

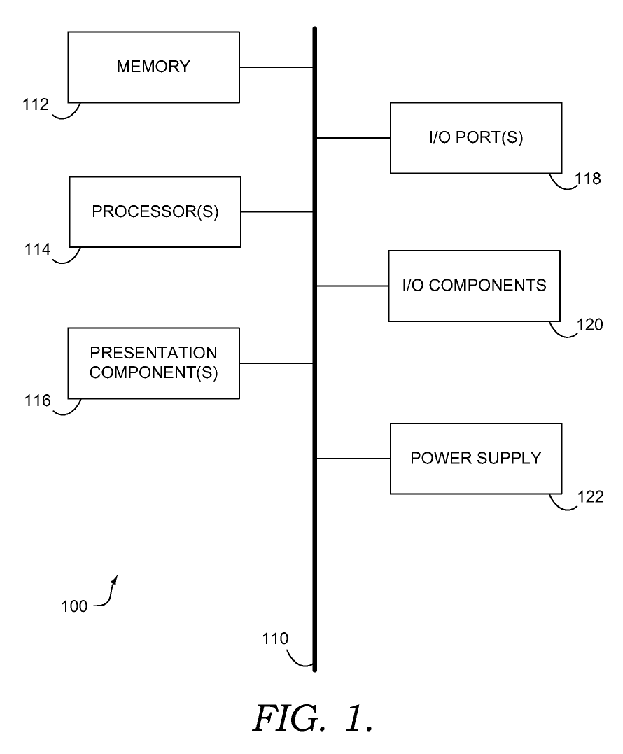

Having briefly described an overview of the present invention, an exemplary operating environment in which various aspects of the present invention may be implemented is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventor hereof recognizes that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer-storage media and communication media. Computer-storage media includes both volatile and nonvolatile, removable and non-removable media implemented in any method or technology for storage of information such as computer-readable instructions, data structures, program modules or other data. Computer-storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100.

The memory 112 includes computer-storage media in the form of volatile and/or nonvolatile memory. The memory 112 may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components 120 include a microphone, joystick, game pad, satellite dish, scanner, printer, wireless device, and the like.

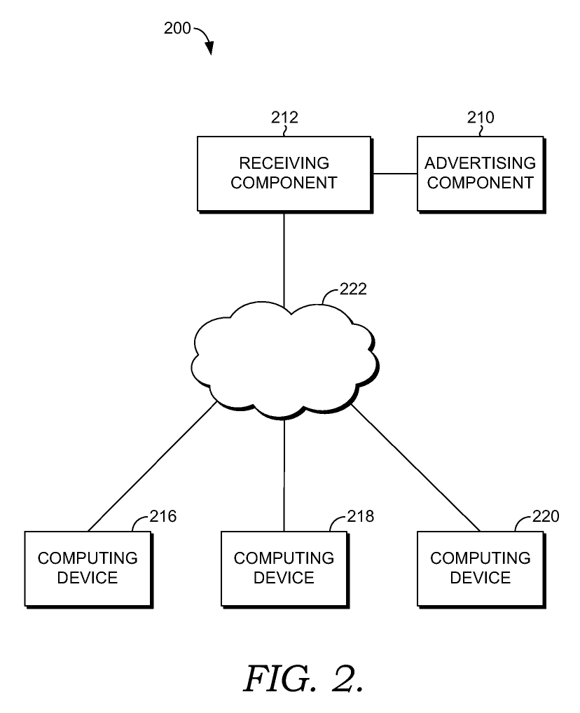

Embodiments of the present invention provide systems, methods, and computer-storage media having computer-executable instructions embodied thereon that, when executed, perform methods in accordance with embodiments hereof, for improving the relevance of contextual ads presented to a user in association with a web resource. With reference now to FIG. 2, a schematic diagram is illustrated showing an exemplary computing system architecture 200 suitable for improving the relevance of contextual ads presented to a user, in accordance with an embodiment of the present invention. The computing system architecture 200 includes an advertising component 210, a receiving component 212, and a plurality of remote computing devices 216, 218, and 220, all in communication with one another through a network 222. The network 222 may be wired, wireless, or both, and include, without limitation, one or more wide area networks (WANs), one or more local area networks (LANs), one or more public networks, such as the Internet, and/or one or more private networks. Such networking environments are commonplace in offices, enterprise-wide computer networks, intranets and the Internet. Accordingly, the network 222 is not further described herein.

The advertising component 210 may be any device and/or entity that is capable of generating and/or communicating an ad. Accordingly, the advertising component 210 may take on a variety of forms, such as a personal computer (PC), a laptop computer, a mobile phone, a personal digital assistant (PDA), a server, or any other device that is capable of generating and/or communicating an ad. In one embodiment, the advertising component 210 may be a computing device such as computing device 100 of FIG. 1. Additionally, the advertising component 210 is configured to be associated with a variety of entities that control generation and/or communication of ads. Such entities may include a web-based entity, a non-web-based entity, or the like. A web-based entity, as used herein, refers generally to an entity that is intended to be accessed solely via a web browser. By way of example only, such a web-based entity may be an online retailer that does not offer non-online means of access, such as in-store retail options. A non-web-based entity, as used herein, refers generally to an entity that may be accessed both via a web browser and by means other than a web browser, and includes in-store options. For example, a retailer having a website and a physical place of operations where business may be conducted with consumers may be characterized as a non-web-based entity.

The advertising component 210, or an entity communicatively associated therewith, is configured to generate and/or communicate contextual ads to be presented to users. A contextual ad, as used herein, refers generally to an ad that is aware of the content of the hosting web resource, that is, an ad that is relevant to the website, webpage, or the like on which it is hosted. Such ads typically include an advertising entity identifier, an advertising entity descriptor, and a URL for the advertising entity. As used herein, an advertising entity identifier refers to a unique identifier that identifies the advertising entity associated with the ad. An advertising entity descriptor, as used herein, refers to a brief description of the advertising entity including, for instance, the trade or field of business of the advertising entity, the duties or responsibilities of the advertising entity, or the like. By way of example only, if a web page for popular vacation destinations is viewed, an ad for airline tickets may additionally be presented in association with the web page as a contextual ad. The airline ticket ad may additionally include an advertising entity identifier identifying the associated advertising entity (e.g., the airline for which the advertised airline tickets are valid), an advertising entity descriptor (e.g., the fact that the advertising airline is an airline, to the extent such would not be obvious to the user), and a URL for the advertising entity.

The contextual ads are communicated via the advertising component 210 to a receiving component 212. The receiving component 212 may be any computing device capable of receiving an ad. Accordingly, the receiving component 212 may take on a variety of forms such as a personal computer (PC), a laptop computer, a mobile phone, a personal digital assistant (PDA), a server, or any other device that is capable of receiving an ad. In one embodiment, the advertising component 210 may be a computing device such as computing device 100 of FIG. 1. The receiving component 212 may be configured to receive a contextual ad from the advertising component 210 in any number of ways. For example, a contextual ad may be downloaded from the advertising component 210.

The contextual ads received by the receiving component 212 may include parameters set by the advertising component 210 by which to be presented to users. Such parameters may include whether the contextual ad is eligible to be introduced as a local contextual ad or to present local contextual information. A local contextual ad, as used herein, refers generally to an ad that includes local contextual information. As used herein, local contextual information refers generally to information that is local, or relates, to a specific user. Local contextual information may include at least one advertising entity identifier and a corresponding advertising entity location. An advertising entity identifier, as previously discussed, refers to a unique identifier that corresponds to and identifies a specific advertising entity. Accordingly, an advertising entity identifier may be used to identify an advertising entity associated with a local contextual ad such as a web-based entity, a non-web-based entity, or the like. An advertising entity location refers generally to a location associated with the identified advertising entity, e.g., an offline retail location carrying products associated with the advertising entity. Local contextual information may be stored in a database.

Upon receiving a contextual ad, the receiving component 212 is configured to determine if the contextual ad is eligible to be presented as a local contextual ad. That is, the receiving component 212 is configured to determine if the contextual ad includes local contextual information associated therewith, e.g., offline retail store locations, and the like. If the contextual ad is not eligible to be introduced as a local contextual ad, it is presented as a contextual ad in the normal manner. If, however, the contextual ad is eligible to be introduced as a local contextual ad, the relevance of the local contextual information as it pertains to the particular user to whom it is going to be presented is determined (as more fully described below) and, if appropriate, the local contextual information is associated with the contextual ad for presentation.

The receiving component 212 is further configured to receive a location associated with a user. A user's location, as used herein, refers generally to a specific location associated with a user, for instance, a geographic location where a user is presently located and/or where a user is generally located (for instance, as evidenced by a user profile). The user's location may include information such as a zip code, a street address, a geographic region, or the like. The user's location may be identified by a user identifier. As used herein, a user identifier refers to a unique identifier associated with a specific user that includes information about a location of that user. The user identifier may be an internet protocol (IP) address, a user log-in, or the like. An exemplary user identifier is Microsoft Windows® Live ID. User identifiers, along with other user information, may be stored in a database. The receiving component 212 is configured to receive a user identifier and identify a user's location associated therewith. Such information is used to improve the relevance of local contextual ads as they pertain to the specific user, as discussed in further detail below.

The receiving component 212 is still further configured to determine the relevance of local contextual information associated with a contextual ad to the particular user to whom it is going to be presented based on the received user's location. Local contextual information may be relevant to a user in that it provides alternatives to online browse and purchase functionality, such as offline store browse and purchase alternatives in or around the user's location. By way of example only, and not limitation, a contextual ad for an offline retailer located in zip code “00000” may be presented to a user whose location is identified as, or to include, zip code “00000.” The user's location is then used to determine the relevance of the local contextual information. That is, the user's location is compared with the local contextual information associated with the advertising entity to determine if the local contextual information is relevant to that particular user. For instance, the advertising entity location associated with the ad is analyzed and its relevance to the user is determined based on the user's location, e.g., advertising entity locations that are in or around to the user's location (e.g., zip code “00000”) are deemed relevant to the user. Users can view relevant local contextual information without entering a user location to determine the relevance of the local contextual information. When a user's location is received by way of a user identifier, receiving component 212 is configured to automatically associate the user's location with an entity's local contextual information when an ad is eligible to present local contextual information.

Upon determining that the local contextual information associated with a contextual ad is relevant to the user, the receiving component 212 is configured to transmit both the contextual ad and associated local contextual information to at least one of the computing devices 216, 218, and 220 for presentation to the user. Each of the computing devices 216, 218, and 220 may be any computing device capable of presenting ads and associated information. In one embodiment, one or more of computing devices 216, 218, and 220 may take on the form of computing device 100, illustrated in FIG. 1. Presenting the contextual ad reveals either the local contextual information associated therewith or the availability of such information upon appropriate user action (e.g., selection, hover behavior, and the like), as more fully described below. It is within the scope of embodiments hereof that presenting local contextual ads may include an audible presentation, a visual presentation, a combination of an audible and a visual presentation, or the like.

Relevant local contextual information is associated with the local contextual ad and presented to a user in a number of ways, namely a local contextual information indicator. The local contextual information indicator may be an iconic link, a textual link, text, symbols, numerals, or any other characters that can indicate availability of local contextual information. The local contextual information may be viewed upon receipt of an appropriate user indication that illustrates the user's desire to view the local contextual information. The user indication to select the local contextual information depends largely on the presented local contextual information indicator. For instance, a textual link reciting “Local Store Information Available” may be selected by clicking the link. Additionally, an icon illustrating the availability of local contextual information may also be selected by selecting (clicking on) the icon. A user indication may also be received and/or recognized by hovering over a local contextual information indicator.

In embodiments, a summarized local contextual information display may be presented upon receiving a user indication to view the local contextual information. A summarized local contextual information display, as used herein, refers generally to a unique local contextual information display that presents a summary of the available local contextual information. Viewing a summarized local contextual information display may or may not redirect a browser to a different web resource. By way of example only, and not limitation, receiving a user indication by hovering over the local contextual indicator may prompt a summarized local contextual information display to be presented to the user. The user is able to view the summary of the local contextual information before directing the browser to the local contextual information display. Additionally, the user may input a subsequent user indication to view the local contextual information display upon viewing the summarized local contextual information display.

The manner in which the contextual ad is presented depends largely on the receiving component 212 determining whether the identified advertising entity associated with the local contextual information is further associated with a customized local contextual information display. A customized local contextual information display, as used herein, refers generally to a unique display of local contextual information available via the identified entity or a web resource associated therewith. A customized local contextual information display may be a web page associated with the advertising identified entity, a unique web page associated with the ad, or the like. By way of example only, and not limitation, a customized local contextual information display may be a web page within the identified advertising entity's web site that lists local, offline store location information. When users are redirected to web resources associated with the advertising entity, the entity may calculate a cost-per-click estimate to evaluate the effectiveness of the contextual ad. Such a calculation may be possible, for instance, due to the redirection to the advertising entity's resources via a re-direction server.

If an advertising entity is associated with a customized local contextual information display, the local contextual information is displayed via the customized local contextual information display. Thus, a single-click accesses local contextual information relevant to the user's location. The user does not need to navigate to an entity web resource and enter a user location. As previously described, the receiving component 212 may be configured to automatically associate the user location, provided by the user identifier, with local contextual information, thus eliminating the need for a user to input any user information in addition to the user identifier.

If an entity is not associated with a customized local contextual information display, the local contextual information is displayed via a non-customized local contextual information display. A non-customized local contextual information display, as used herein, refers generally to a display of local contextual information that is not accessible through means other than receiving a user indication of the local contextual information indicator and is not provided by the advertising identified entity. As with the customized local contextual information display, a single-click allows a user to access local contextual information without input of a user location.

In embodiments, advertising entities associated with an ad may receive monetary rewards when users view and, consequently, take action based on a presented ad. Presented ads may be associated with an incentive to encourage users to act in response to the information presented in the ad. Such incentives include coupons, rebates, or the like. The incentives are associated with an ad identifier that identifies the ad associated therewith. When a user presents an incentive to a vendor, the ad identifier indicates the advertising entity associated with the ad and the use of the incentive is reported to the identified advertising entity. This enables entities, advertisers, advertising companies, advertising publishers, etc., to track the use of incentives related to ads and thus, in turn, evaluate the effectiveness of particular ads.

Those skilled in the art will appreciate that the present invention contemplates the presence of additional components and/or subcomponents of the illustrated system 200, and the components and/or subcomponents may be combined with one another and/or separated into new components and subcomponents.

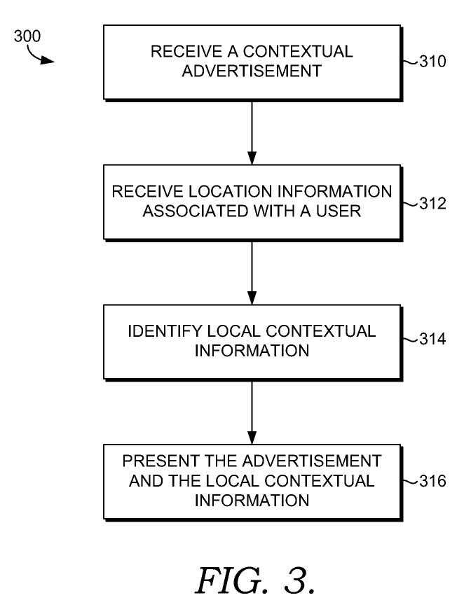

With reference now to FIG. 3, an exemplary method 300 for providing local contextual information in association with contextual ads presented to a user in association with a web resource is illustrated. Initially, as indicated at block 310, a contextual ad is received (e.g., utilizing receiving component 212 of FIG. 2). The received contextual ad includes local contextual information associated therewith that is capable of being presented to the user. As indicated at block 312, location information associated with the user is received (for instance utilizing receiving component 212 of FIG. 2). The user's location may be received, for instance, via a user identifier. The user identifier may be user log-in profile information, an internet protocol address, or the like.

As indicated at block 314, local contextual information that is relevant to the particular user is identified based on the user's identified location. The local contextual information includes at least one entity identifier that identifies an entity associated with the contextual ad and at least one offline location associated with the identified entity. The user's location is used to determine if any of the at least one offline locations associated with the identified entity correlate with the user's location. If an offline location associated with an identified entity is at or near the user's location, the local contextual information is determined to be relevant. The contextual ad, including the local contextual information, is then presented to the user, as indicated at block 316. The local contextual information presented to the user is generally presented such that the most relevant information is presented to the user first.

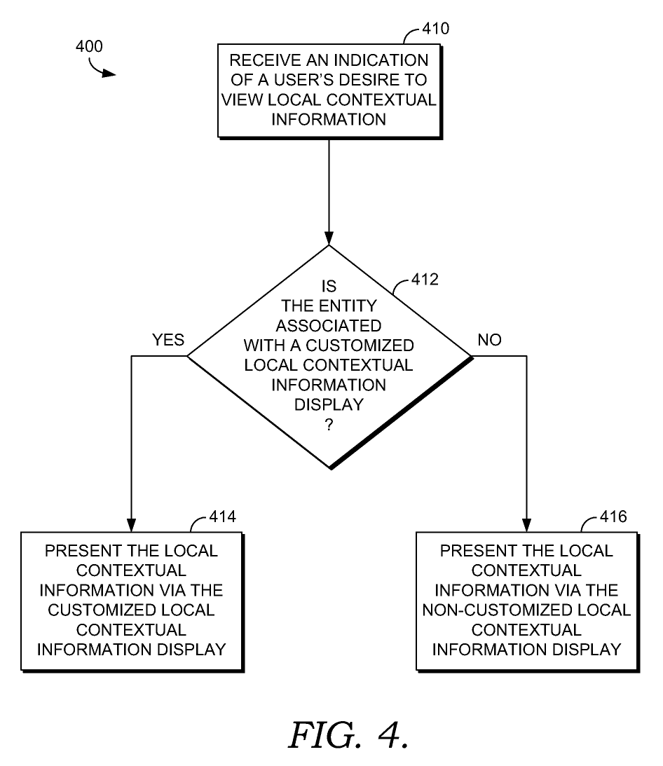

With reference now to FIG. 4, a flow diagram is illustrated showing a method 400 for presenting local contextual information in association with local contextual ads to a user in association with a web resource, in accordance with an embodiment of the present invention. The computer-implemented method initiates at step 410 when an indication of a user's desire to view local contextual information associated with a presented contextual ad is received utilizing, for instance, the receiving component 212 of FIG. 2. The local contextual information received includes at least one entity identifier that identifies an entity associated with the contextual ad and a location associated with the identified entity. Receiving an indication of a user's desire to view local contextual information may include receiving an indication of a user's selection of a local contextual information indicator. The local contextual information indicator may be an icon, a link, or the like. The local contextual information indicator may be selected by clicking the local contextual information indicator or hovering over the local contextual information indicator. In embodiments, a summarized local contextual information display may be presented to a user upon receiving a selection of the local contextual information indicator.

As indicated at block 412, by way of a processor, a determination whether the entity is associated with a customized local contextual information display is made. A customized local contextual information display is a display that is available through the entity or a web resource associated therewith. Upon determining that an entity is associated with a customized local contextual information display, the local contextual information is presented via the customized local contextual information display, as indicated at block 414. Upon determining that an entity is not associated with a customized local contextual information display, the local contextual information is presented via a non-customized local contextual information display, as indicated at block 416. A non-customized local contextual information display is a display that is accessible only through the ad and is not provided by the identified entity.

The presented ad may further include an incentive to encourage a user to act on the ad. The incentive may be a coupon, rebate, or the like. Incentives include an ad identifier that identifies that ad associated therewith. When an incentive is redeemed, the ad identifier is identified. By identifying the ad associated with the incentive, the entity associated with the ad is available for identification. The entity may be notified of the redeemed incentive.

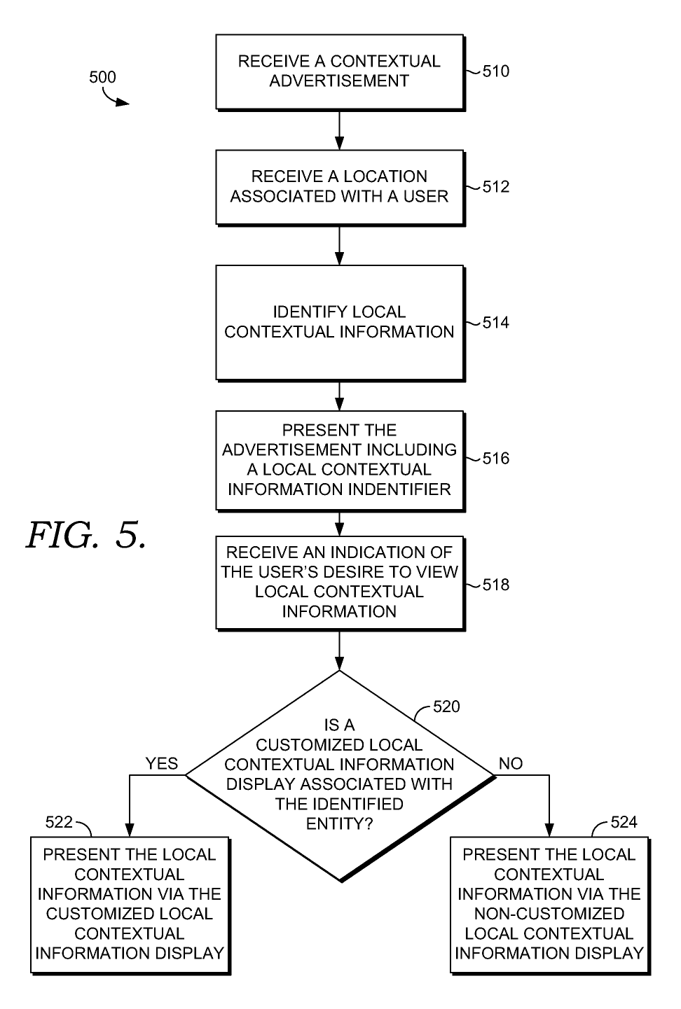

Referring now to FIG. 5, a flow diagram is illustrated showing a method 500 for improving the relevance of contextual ads presented to a user in association with a web resource, in accordance with an embodiment of the present invention. As indicated at block 510, a contextual ad is received, for instance, utilizing receiving component 212 of FIG. 2. The contextual ad is eligible to present local contextual information, that is, includes local contextual information associated therewith that may be presented to a user.

A location associated with a user is received, as indicated at block 512 (for instance, utilizing receiving component 212 of FIG. 2). In one embodiment, the location associated with a user is identified via a user identifier. The user identifier may be accessed from a database. The user identifier may be user log-in profile information, an internet protocol address, or the like. Based on the user's location received at block 512, local contextual information is identified, as indicated at block 514. Local contextual information includes at least one non-web-based entity identifier that identifies a non-web-based entity associated with the contextual ad. The local contextual information further includes a location associated with the identified non-web-based entity. A non-web-based entity has offline accessible options. In other words, means other than a web browser are available to access a non-web-based entity. The contextual ad is then presented to the user, as indicated at block 516.

An indication of a user's desire to view the local contextual information is received, as indicated at step 518 (for instance, utilizing receiving component 212 of FIG. 2). In embodiments, receiving an indication of a user's desire to view local contextual information includes receiving a user's selection of a local contextual information indicator. The local contextual information indicator may be an icon, a link, or the like. The local contextual information indicator may be selected by clicking the local contextual information indicator, hovering over the local contextual information indicator, or hovering over the contextual ad itself. In embodiments, a summarized local contextual information display may be presented to a user upon receiving a selection of the local contextual information indicator.

Relevancy of the local contextual information is identified based on the location associated with the user and a correlation of the user's location with the location associated with the non-web-based entity. The local contextual information is presented to a user in order of relevancy, thus, the most relevant local contextual information is presented to a user first via a customized local contextual information display or a non-customized local contextual information display.

A determination whether the non-web-based entity is associated with a customized local contextual information display is then made, as indicated at step 520. A customized local contextual information display is a display that is available through an entity or web resources associated therewith. Upon determining that the non-web-based entity is associated with a customized local contextual information display, the local contextual information is presented via the customized local contextual information display, as indicated at block 522. Upon determining that an entity is not associated with a customized local contextual information display, the local contextual information is presented via a non-customized local contextual information display, as indicated at block 524. A non-customized local contextual information display is a display that is accessible only through the ad and is not provided the identified entity.

The foregoing descriptions of embodiments of the invention are illustrative, and modifications in configuration and implementation will occur to persons skilled in the art. For instance, while the present invention has generally been described with relation to FIGS. 1-5, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

Having thus described the invention, what is claimed is:

1. One or more computer-storage media having computer-executable instructions embodied thereon that, when executed by a computing device, perform a method for providing local contextual information in association with contextual advertisements presented to a user in association with a web resource, the method comprising:
receiving a contextual advertisement for presentation to the user;
receiving location information associated with the user;
based on the user's location information, identifying local contextual information, wherein the local contextual information includes at least one entity identifier that identifies an entity associated with the contextual advertisement and an offline location associated with the identified entity; and
presenting the advertisement and the local contextual information.

2. The one or more computer-storage media of claim 1, wherein receiving the location information associated with the user includes receiving a user identifier associated with the user.

3. The one or more computer-storage media of claim 2, wherein receiving the user identifier associated with the user comprises receiving the user identifier as an internet protocol address associated with the user.

4. The one or more computer-storage media of claim 2, wherein receiving the user identifier associated with the user comprises receiving a user log-in profile associated with the user.

5. The one or more computer-storage media of claim 1, wherein receiving a contextual advertisement for presentation to the user includes receiving a contextual advertisement having local contextual information associated therewith that is capable of presentation to the user.

6. The one or more computer-storage media of claim 1, wherein presenting the advertisement and the local contextual information includes presenting the advertisement and a local contextual information indicator that indicates availability of local contextual information upon receipt of appropriate user action.

7. The one or more computer-storage media of claim 1, wherein at least one of the local contextual information and the location associated with the user is extracted from a data store.

8. A computer-implemented method that, when executed by a computing device, presents local contextual information in association with local contextual advertisements to a user in association with a web resource, the method comprising:
receiving an indication of a desire of the user to view local contextual information associated with a presented contextual advertisement, wherein the local contextual information includes at least one entity identifier that identifies an entity associated with the contextual advertisement and an offline location associated with the identified entity;
by way of a processor, determining whether the identified entity is associated with a customized local contextual information display,
wherein if it is determined that the identified entity is associated with a customized local contextual information display, presenting the local contextual information via the customized local contextual information display, and
wherein if it is determined that the identified entity is not associated with a customized local contextual information display, presenting the local contextual information via a non-customized local contextual information display.

9. The method of claim 8, wherein the customized local contextual information display comprises a display that is provided by the identified entity or a web resource associated with the identified entity.

10. The method of claim 8, wherein the non-customized local information display is a display that is provided by a web resource other than the identified entity or a web resource associated therewith.

11. The method of claim 8, wherein receiving the indication of the user's desire to view local contextual information associated with the presented contextual advertisement comprises receiving a use's selection of a local contextual information indicator.

12. The method of claim 11, wherein receiving the user's selection of a local contextual information indicator includes receiving the user's selection of one of a link to a web resource and an icon.

13. The method of claim 11, wherein receiving the user's selection of a local contextual information indicator includes receiving an indication that the user has clicked on the local contextual information indicator.

14. The method of claim 8, wherein receiving the indication of the user's desire to view local contextual information associated with the presented contextual advertisement comprises receiving an indication that the user is hovering over the local contextual information indicator.

15. The method of claim 8, further comprising presenting a summarized local contextual information display upon receiving the indication of the user's desire to view local contextual information associated with the presented advertisement.

16. The method of claim 8, further comprising presenting an incentive associated with the presented contextual advertisement, wherein the incentive includes an advertisement identifier identifying the particular contextual advertisement associated therewith.

17. One or more computer-storage media having computer-executable instructions embodied thereon that, when executed by a processor, perform a method for improving the relevance of contextual advertisements presented to a user in association with a web resource, the method comprising:
receiving a contextual advertisement;
receiving a location associated with a user;
based on the user's location, identifying local contextual information, wherein the local contextual information includes at least one non-web-based entity identifier that identifies a non-web-based entity associated with the contextual advertisement and a location associated with the identified non-web-based entity, wherein the non-web-based entity is an entity accessible by means other than a web browser;
presenting the contextual advertisement and a local contextual information indicator;
receiving an indication of the user's desire to view the local contextual information associated with the presented advertisement;
determining whether the non-web-based entity is associated with a customized local contextual information display,
wherein if it is determined that the non-web-based entity is associated with a customized local contextual information display, presenting the local contextual information via the customized local contextual information display, and
wherein if it is determined that the non-web-based entity is not associated with a customized local contextual information display, presenting the local contextual information via a non-customized local contextual information display.

18. The method of claim 17, wherein receiving the indication of the user's desire to view local contextual information associated with the presented advertisement further includes receiving a user's selection of a local contextual information indicator, wherein the local contextual information indicator is an icon or a link.

19. The method of claim 17, wherein receiving the indication of the user's desire to view local contextual information associated with the presented advertisement includes receiving an indication of a user's hover behavior over a local contextual information indicator.

20. The method of claim 17, wherein the customized local contextual information display is a display that is available through the identified entity or a web resource associated therewith, and wherein the non-customized local information display is a display that is not available through the identified entity or a web resource associated therewith.
